(19) United States
(12) Patent Application Publication
(10) Pub. No.: US 2004/0081436 A1
(43) Pub. Date: Apr. 29, 2004

(54) Data recording apparatus, data reproduction apparatus, data recording program, data reproduction program, recording medium and data recording medium

(75) Inventors: Kenichiro Tada, Tokorozawa-shi (JP); Ken Miyagawa, Tokorozawa-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/684,500

(22) Filed: Oct. 15, 2003

(30) Foreign Application Priority Data
Oct. 18, 2002 (JP) P2002-304732

(51) Int. Cl. H04N 5/76

(52) U.S. Cl. 386/121; 386/111

(57) ABSTRACT

A data-recording apparatus is provided that is capable of recording source video images such that the memory capacity of a buffer memory that is used when using the I pictures contained in the source video images to create new video image for fast-forward reproduction can be set quickly and properly.

When video images comprising a plurality of still images are recorded on a hard disc HD according to the MPEG method, the I pictures of the pictures in the video images that are used in the fast-forward reproduction process of the video images are detected, and the maximum amount of data of the I picture from among those detected I pictures that has the maximum amount of data is detected as maximum-size data MFRS, and that detected maximum-size data MFRS is recorded on the hard disc HD on which the video images are recorded.

### BACKGROUND OF THE INVENTION

1. Field of the Invention

This invention relates to a data-recording apparatus, data-reproduction apparatus, data-recording program, data-reproduction program, recording medium and data-recording medium, and more particularly to a data-recording apparatus and data-recording program that records video images input from the outside on a recording medium, a data-reproduction apparatus and data-reproduction program that converts recorded video images to special reproduction images for special reproduction, a recording medium for recording video images, and a data-recording medium on which the data-recording program or data-reproduction program is recorded.

2. Description of the Related Art

Recently, the DVD (Digital Versatile Disc), which has greatly improved recording density when compared with a conventional optical disc or CD (Compact Disc), has become commonplace.

Here, video images for one movie are recorded together with the corresponding audio on a DVD, however in this case the video images are compressed and recorded in MPEG format. Here, after the video images have been compressed using MPEG format, they are recorded on the DVD as I pictures, P (Predictive-coded) pictures and B (Bi-directionally predictive-coded) pictures.

On the other hand, in addition to reproduction at normal (original) reproduction speed along the time axis used in recording the video images, the method of reproduction used for reproducing the video images recorded on the DVD, can also be a reproduction method called special reproduction, and the most common method of reproduction of this special reproduction method is fast-forward reproduction. Conventionally, in this fast-forward special reproduction method, only the I pictures of the pictures recorded on the DVD are detected, and fast-forward reproduction is performed by continuously reproducing these detected I pictures.

To explain the method for performing this conventional fast-forward reproduction in more detail, after performing an operation to instruct that fast-forward reproduction be performed, first, each of the I pictures is detected, and by lining them up along the time axis according to the MPEG method, new video images for fast-forward reproduction are created and output.

On the other hand, generally when creating new video images according to the MPEG method, it is common to first create video images using a buffer memory where the original video images are temporarily stored. In that case, it is common to use part of a memory that is equipped in the apparatus for other purposes as the buffer memory, and use it for creating the video images, and by setting in advance the minimum amount of memory space required for creating the video images, part of this memory is set apart as the buffer memory. Also, second, when creating new video images, it is necessary to consider the amount of data that will be transferred when outputting the created images to the outside.

Moreover, when creating new video images for fast-forward reproduction taking into consideration these normal methods of creating a video according to the MPEG method, it is necessary to detect the amount of data of all of the I pictures that will make up the new video images, and then to create the new video images for which the amount of memory used as the buffer memory and the transfer rate for transferring the video images to the outside are optimally set.

However, in this conventional method of creating new video images for fast-forward reproduction, in order to properly set the amount of memory to be used as the buffer memory, and to set the transfer rate for transferring the video images to the outside, it is necessary to detect in advance the amount of I-picture data contained in the original video images for which fast-forward reproduction is to be performed for the execution time of that fast-forward reproduction, and then create the video images for fast-forward reproduction. Therefore, if the total amount of I-picture data is not completely detected, it is not possible to set the amount of memory to be used as the buffer memory, and as a result, there are problems in that the construction of the data-reproduction apparatus for executing fast-forward reproduction becomes complicated and the amount of processing increases, as well as it is not possible to properly set the transfer rate to the outside.

### SUMMARY OF THE INVENTION

Thereupon, the present invention has been made in view of the above-described points in problem and has an object to provide: a data-recording apparatus and data-recording program that are capable of recording original video images such that the amount of memory to be used as a buffer memory and the transfer rate to the outside can be quickly and properly set when creating new video images for fast-forward reproduction using the I pictures contained in the original video images; a data-reproduction apparatus and data-reproduction program that are capable of quickly and properly creating video images for fast-forward reproduction based on the video images recorded by the data-recording apparatus; a data-recording medium on which the data-recording program or data-reproduction program are recorded, and a recording medium on which data recorded by the data-recording apparatus is recorded.

The above object of the present invention can be achieved by a data-recording apparatus that records video images comprising a plurality of still images, onto a recording medium. The data-recording apparatus is provided with: a maximum-data-amount-detection device for detecting the maximum amount of data of a still image for special reproduction among a plurality of still images; and a recording device for recording the detected maximum amount of data onto the recording medium on which the video images are recorded.

According to the data-recording apparatus, since detected maximum amount of data of the still image for special reproduction is recorded onto the recording medium, in the special reproduction process of the recorded video images, it is possible to use the still image to properly and efficiently set the conversion specification, such as the memory capacity of a memory used when converting video images to a special-reproduction images.

In one aspect of the data-recording apparatus, the video images are video images that have been compressed according to the MPEG2 (Motion Picture Experts Group 2) method; and the still images for special reproduction are the I (Intra-coded) pictures in the MPEG2 method.

According to this aspect, since detected maximum amount of data of the I pictures for special reproduction is recorded onto the recording medium, in the special reproduction process of the recorded video images, it is possible to use the I pictures to properly and efficiently set the conversion specification, such as the memory capacity of a memory used when converting MPEG2 video images to a special-reproduction images.

The above object of the present invention can be achieved by a data-reproduction apparatus that reproduces video images that are recorded on a recording medium by a data-recording apparatus, and converts them into special reproduction images for special reproduction. The data-recording apparatus is provided with: a maximum-data-amount-detection device for detecting the maximum amount of data of a still image for special reproduction among a plurality of still images; and a recording device for recording the detected maximum amount of data onto the recording medium on which the video images are recorded. The data-reproduction apparatus is provided with: a reproduction device for reproducing the video images from the recording medium; a detection device for detecting the recorded maximum data amount from the recording medium; a setting device for setting conversion specification based on the detected maximum data amount when converting the video images to the special-reproduction images; and a conversion device for converting the reproduced video images to the special-reproduction images based on the set conversion specification.

According to the data-reproduction apparatus, since detected maximum amount of data of the still image for special reproduction have been recorded onto the recording medium, in the special reproduction process of the recorded video images, it is possible to use the still image to properly and efficiently set the conversion specification, such as the memory capacity of a memory used when converting video images to a special-reproduction images. Therefore, when performing the special-reproduction process, it is not necessary to detect the amount of data for all of the still image, so it is possible to simplify the construction of the data-reproduction that performs the special-reproduction process, and it is possible to reduce the processing burden when performing special-reproduction.

In one aspect of the data-reproduction apparatus, the conversion specification is memory capacity of a temporary memory device for temporarily storing video images when converting the video images to the special-reproduction images, and the temporary memory device is secured inside a memory device of the data-reproduction apparatus.

According to this aspect, the conversion specification is the memory capacity of the temporary memory device for temporarily storing video images, so it is possible to maintain a memory space having a minimum necessary memory capacity such that a memory is not unnecessarily used.

In another aspect of the data-reproduction apparatus, the conversion specification is the bandwidth used when outputting the special-reproduction images to the outside after conversion.

According to this aspect, the bandwidth used when outputting the special-reproduction images to the outside after conversion, so it is possible to optimize the required amount of bandwidth when outputting the special-reproduction images to the outside after conversion.

The above object of the present invention can be achieved by a data-recording method for recording video images comprising a plurality of still images, onto a recording medium. The data-recording method is provided with: a maximum-data-amount-detection process for detecting the maximum amount of data of a still image for special reproduction among a plurality of still images; and a recording process for recording the detected maximum amount of data onto the recording medium on which the video images are recorded.

According to the data-recording method, since detected maximum amount of data of the still image for special reproduction is recorded onto the recording medium, in the special reproduction process of the recorded video images, it is possible to use the still image to properly and efficiently set the conversion specification, such as the memory capacity of a memory used when converting video images to a special-reproduction images.

The above object of the present invention can be achieved by a data-reproduction method for reproducing video images that are recorded on a recording medium using a data-recording method, and converting them into special reproduction images for special reproduction. The data-recording method is provided with: a maximum-data-amount-detection process for detecting the maximum amount of data of a still image for special reproduction among a plurality of still images; and a recording process for recording the detected maximum amount of data onto the recording medium on which the video images are recorded. The data-reproduction method is provided with: a reproduction process for reproducing the video images from the recording medium; a detection process for detecting the recorded maximum data amount from the recording medium; a setting process for setting conversion specification based on the detected maximum data amount when converting the video images to the special-reproduction images; and a conversion process for converting the reproduced video images to the special-reproduction images based on the set conversion specification.

According to the data-reproduction method, since detected maximum amount of data of the still image for special reproduction have been recorded onto the recording medium, in the special reproduction process of the recorded video images, it is possible to use the still image to properly and efficiently set the conversion specification, such as the memory capacity of a memory used when converting video images to a special-reproduction images. Therefore, when performing the special-reproduction process, it is not necessary to detect the amount of data for all of the still image, so it is possible to simplify the construction of the data-reproduction that performs the special-reproduction process, and it is possible to reduce the processing burden when performing special-reproduction.

The above object of the present invention can be achieved by a computer data signal embodied in a carrier wave. The computer data signal represents a sequence of instructions, which executed by a recording computer included in a data-recording apparatus, which records video images comprising a plurality of still images onto a recording medium, the instructions cause the recording computer to function as: a maximum-data-amount-detection device for detecting the maximum amount of data of a still image for special reproduction among a plurality of still images; and a recording device for recording the detected maximum amount of data onto the recording medium on which the video images are recorded.

According to the computer data signal, the recording computer reads out the computer data signal from the carrier wave and the recording computer functions in such a manner that, since detected maximum amount of data of the still image for special reproduction is recorded onto the recording medium, in the special reproduction process of the recorded video images, it is possible to use the still image to properly and efficiently set the conversion specification, such as the memory capacity of a memory used when converting video images to a special-reproduction images.

The above object of the present invention can be achieved by a computer data signal embodied in a carrier wave. The computer data signal represents a sequence of instructions, which executed by a reproduction computer included in a data-reproduction apparatus, which reproduces the video images that are recorded on the recording medium by a data-recording apparatus that records video images comprising a plurality of still images onto a recording medium. The data-recording apparatus is provided with: a maximum-data-amount-detection device for detecting the maximum amount of data of a still image for special reproduction among a plurality of still images; and a recording device for recording the detected maximum amount of data onto the recording medium on which the video images are recorded. The data-reproduction apparatus converts them into special reproduction images for the special reproduction, The instructions cause the reproduction computer to function as: a reproduction device for reproducing the video images from the recording medium; a detection device for detecting the recorded maximum data amount from the recording medium; a setting device for setting conversion specification based on the detected maximum data amount when converting the video images to the special-reproduction images; and a conversion device for converting the reproduced video images to the special-reproduction images based on the set conversion specification.

According to the computer data signal, the reproduction computer reads out the computer data signal from the carrier wave and the reproduction computer functions in such a manner that, since detected maximum amount of data of the still image for special reproduction have been recorded onto the recording medium, in the special reproduction process of the recorded video images, it is possible to use the still image to properly and efficiently set the conversion specification, such as the memory capacity of a memory used when converting video images to a special-reproduction images. Therefore, when performing the special-reproduction process, it is not necessary to detect the amount of data for all of the still image, so it is possible to simplify the construction of the data-reproduction that performs the special-reproduction process, and it is possible to reduce the processing burden when performing special-reproduction.

The above object of the present invention can be achieved by a data-recording medium. The data-recording medium records a program for recording data so as to be readable by a recording computer included in a data-recording apparatus, the program allows the recording computer to function as: a maximum-data-amount-detection device for detecting the maximum amount of data of a still image for special reproduction among a plurality of still images; and a recording device for recording the detected maximum amount of data onto the recording medium on which the video images are recorded.

According to the data-recording medium, the recording computer reads out the program from the data-recording medium and it functions in such a manner that, since detected maximum amount of data of the still image for special reproduction is recorded onto the recording medium, in the special reproduction process of the recorded video images, it is possible to use the still image to properly and efficiently set the conversion specification, such as the memory capacity of a memory used when converting video images to a special-reproduction images.

The above object of the present invention can be achieved by a data-recording medium. The data-recording medium records a program for reproducing data so as to be readable by a reproduction computer included in a data-reproduction apparatus, the program allows the reproduction computer to function as: a reproduction device for reproducing the video images from the recording medium; a detection device for detecting the recorded maximum data amount from the recording medium; a setting device for setting conversion specification based on the detected maximum data amount when converting the video images to the special-reproduction images; and a conversion device for converting the reproduced video images to the special-reproduction images based on the set conversion specification.

According to the data-recording medium, the reproduction computer reads out the program from the data-recording medium and it functions in such a manner that, since detected maximum amount of data of the still image for special reproduction have been recorded onto the recording medium, in the special reproduction process of the recorded video images, it is possible to use the still image to properly and efficiently set the conversion specification, such as the memory capacity of a memory used when converting video images to a special-reproduction images. Therefore, when performing the special-reproduction process, it is not necessary to detect the amount of data for all of the still image, so it is possible to simplify the construction of the data-reproduction that performs the special-reproduction process, and it is possible to reduce the processing burden when performing special-reproduction.

The above object of the present invention can be achieved by a recording medium. The recording medium is provided with: a video-image-recording area in which video images comprising a plurality of still images are recorded; and a maximum-data-amount-recording area in which the maximum amount of data of a still image for special reproduction among a plurality of still images is recorded.

According to the recording medium, since detected maximum amount of data of the still image for special reproduction have been recorded onto the recording medium, in the special reproduction process of the recorded video images, it is possible to use the still image to properly and efficiently set the conversion specification, such as the memory capacity of a memory used when converting video images to a special-reproduction images.

In one aspect of the recording medium, the video images are video images that have been compressed according to the MPEG2 method; and the still images for special reproduction are the I pictures in the MPEG2 method.

According to this aspect, since detected maximum amount of data of the I pictures for special reproduction is recorded onto the recording medium, in the special reproduction process of the recorded video images, it is possible to use the I pictures to properly and efficiently set the conversion specification, such as the memory capacity of a memory used when converting MPEG2 video images to a special-reproduction images.

### BRIEF DESCRIPTION OF THE DRAWINGS

FIG. 1 is a drawing showing the recording format of an embodiment of the invention.

FIG. 2 is a block diagram showing the construction of the data-recording/reproduction apparatus of an embodiment of the invention.

FIG. 3 is a block diagram showing the detailed construction of the data-recording/reproduction apparatus of an embodiment of the invention.

FIG. 4 is a flowchart showing the recording process in an embodiment of the invention.

FIG. 5 is a flowchart showing the fast-forward reproduction process in an embodiment of the invention.

### DESCRIPTION OF THE PREFERRED EMBODIMENTS

The preferred embodiments of the invention will be explained based on the drawings.

In the embodiments explained below, the invention is applied to a data-recording/reproduction apparatus that is capable of recording digital data (including images and sound) that is broadcast by a digital broadcast such as BS (Broadcast Satellite) digital broadcast on to a hard disc as the recording medium, and that is capable of reproducing the recorded digital data.

The data-recording/reproduction apparatus of these embodiments, when reproducing the digital data, in addition to being capable of executing normal reproduction by reproducing the digital data at normal speed, is also capable of executing fast-forward reproduction of the video images contained in the digital data.

Also, in the embodiments explained below, the digital data is presumed to be broadcast according to transport-stream standard defined by the MPEG2 standard, which is well known as a standard for video compression technology.

(I) Recording Format

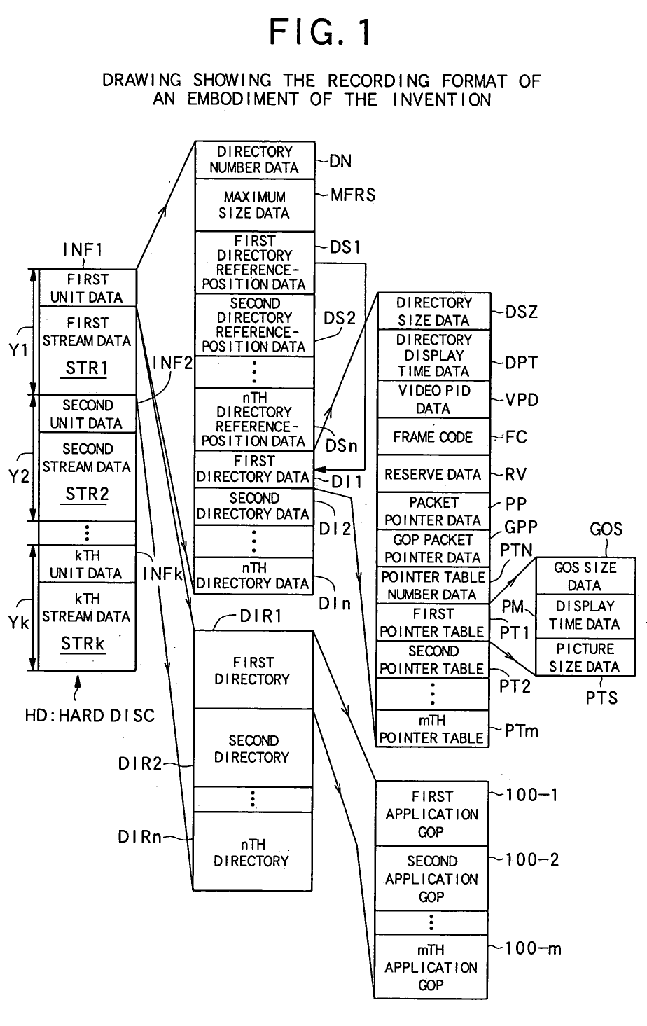

First, before explaining the data-recording/reproduction apparatus of this embodiment in detail, FIG. 1 will be used to explain the logical recording format used when the data-recording/reproduction apparatus records digital data onto the hard disc.

FIG. 1 shows the hierarchy and frame structure of the logical format of the digital data after it has been recorded onto the hard disc based on that recording format. Also, the recording format shown in FIG. 1 is the logical recording format that is used when recording the digital data of this embodiment onto the hard disc, and the well-known physical format that is used for the hard disc is used as is as the logical recording format that is used during recording.

Next, as a premise for the detailed explanation for the recording format, it is presumed that the state of the recorded digital data is managed effectively according to the contents, so a summary of various concepts adopted for the recording format will be explained.

As a first concept, in the recording format below, the concept of the ‘unit’ will be used when handling a group of recorded digital data. That is, the ‘unit’ is a group of digital data that have been recorded continuously over time onto the hard disk during recording. More specifically, when digital data are broadcast by a BS digital broadcast, for example, one event defined for the BS digital broadcast, corresponds to one unit.

Next, as a second concept, in a BS digital broadcast for example, in the case of packets that store image data in the transport stream, a plurality of packets having the same ID number (this is an ID number to identify packets and hereafter this ID number will be called the PID (Packet ID)) may be handled as a single group, however, in the recording format mentioned above, the concept of the ‘directory’ will be used for a group of digital data comprising a plurality of packets having the same PID. In other words, the directory is a concept that specifies all or part of one unit, and uses one PID to specify that.

Finally, as a third concept, in the recording format below, the concept of an ‘application GOP’ is used, which is a group of image data among the image data contained in one directory that corresponds to one GOP (Group of Pictures) that is defined by the MPEG2 standard.

Next, FIG. 1 will be used to explain in detail the logical recording format of this embodiment based on the concepts described above.

As shown in FIG. 1, there is a plurality of units (‘k’ number of units in FIG. 1) Y1 to Yk that are logically arranged on the hard disc HD after the required digital data have been recorded.

Next, one unit (for example, the first unit Y1), comprises first-unit data INF1, which is management data for managing the entire first unit Y1, and first-stream data STR1, which is the actual digital data of the digital data that is broadcast and recorded on the hard disc that belongs to the first unit Y1.

Also, one stream of data (for example, first-stream data STR1) comprises one or a plurality of directories (‘n’ number of directories in the case of the first unit Y1 in FIG. 1) DIR1 to DIRn. Here, a series of continuous numbers are assigned to the directories DIR contained in one stream of data STR.

On the other hand, one unit of data (for example, first-unit data INF1) comprises: directory-number data DN (2 bytes) that indicates the number of directories DIR contained in a unit Y (there are ‘n’ number of directories in the first unit Y1 in FIG. 1); maximum-size data MFRS, which is data indicating the amount of data in the I picture from among the I pictures of a video contained in a unit Y that has the largest amount of data; directory-reference-position data (4 bytes) DS1 to DSn, which indicates the recording position on the hard disc HD of directory data DI, to be described later and which is correlated to each directory DIR in order to manage the directories in one unit Y, as a relative position based on the recording position of the start of the unit Y to which that directory DIR belongs; and directory data DI1 to DIn, which are recorded having the recording positions on the hard disc HD indicated by each item of directory-reference-position data DS as the starting position. Here, the number of items of directory data DI contained is the same number of directories in the unit Y in which that directory data DI is contained.

On the other hand, as shown in FIG. 1, one directory DIR (for example, the first directory DIR1) comprises one or a plurality of application GOP 100 (‘m’ number of in the case of the first directory DIR1). Here, in one directory a series of continuous numbers are assigned to the application GOP 100 contained in that directory DIR.

Next, the detailed configuration of the directory data DI will be explained.

As shown in FIG. 1, one item of directory data DI comprises: directory-size data DSZ (4 bytes) that indicates the number of packets contained in the corresponding directory DIR; directory-display-time data DPT (4 bytes) that indicates the total display time for the image data contained in that directory DIR; video PID data VPD (2 bytes), which is a PID that is common for all of the packets in that directory DIR; frame code FC (1 byte) that indicates the basic display frequency of the video data contained in each packet; reserve data RSV (1 byte), which is meaningless reserve data; packet-pointer data PP (4 bytes) that indicates the position on the hard disc HD where the first packet in the directory is recorded as the number of bytes from the start of that directory; GOP packet-pointer data GPP (4 bytes) that indicates the position on the hard disc HD where the first application GOP in the directory DIR is recorded as the number of packets from the position on the hard disc HD where the first packet in that directory DIR is recorded; pointer-table-number data PTN (4 bytes), which is data that indicates the number of application GOP contained in one directory DIR; and a pointer table PT1 to PTm, which is management data for managing corresponding application GOP.

Here, the number of items in the pointer table PT is the same as the number of application GOP contained in the directory DIR that corresponds to the directory data DI where that pointer table PT is contained.

Finally, the detail configuration of the pointer table PT will be explained.

As shown in FIG. 1, one pointer table PT comprises: GOP size data GOS that indicates the amount of digital data contained in the application GOP 100 that corresponds to that pointer table PT; display-time data PM that indicates the display time of digital data contained in that application GOP 100 (in other words the reproduction time for that application GOP); and picture-size data PTS that indicates the amount of data in the I picture that is reproduced first, of the I pictures contained in that application GOP 100.

The hierarchical recording format explained above is used to record digital data, so in the data-recording/reproduction apparatus explained below, it is possible to efficiently reproduce the recorded digital data.

(II) Embodiment of the Data Recording/Reproduction Apparatus

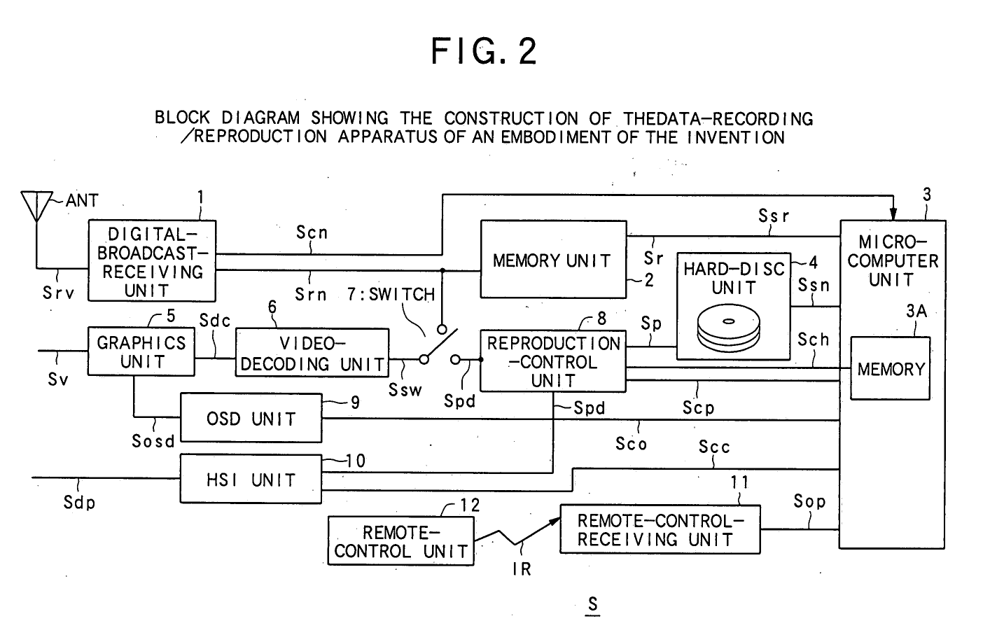

Next, an embodiment of the data-recording/reproduction apparatus that records digital data received from a BS digital broadcast onto a hard disc HD according to the recording format explained in FIG. 1, and that reproduces that recorded digital data will be explained using FIG. 2 to FIG. 5.

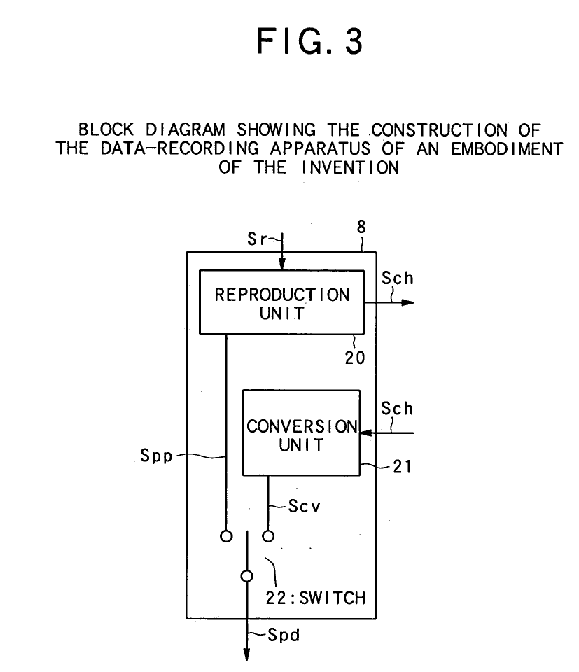

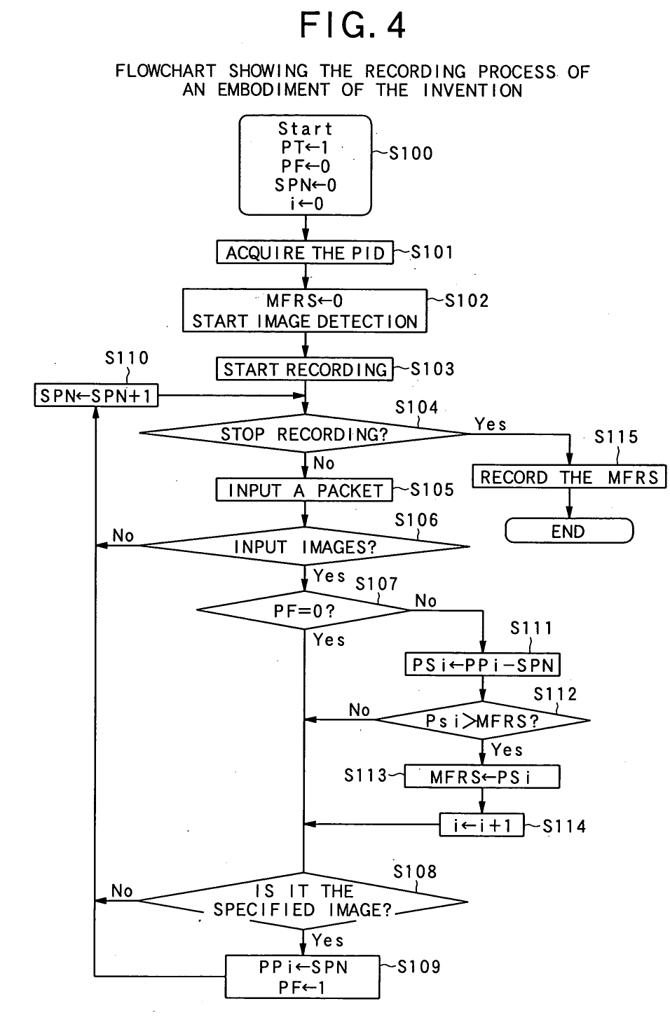

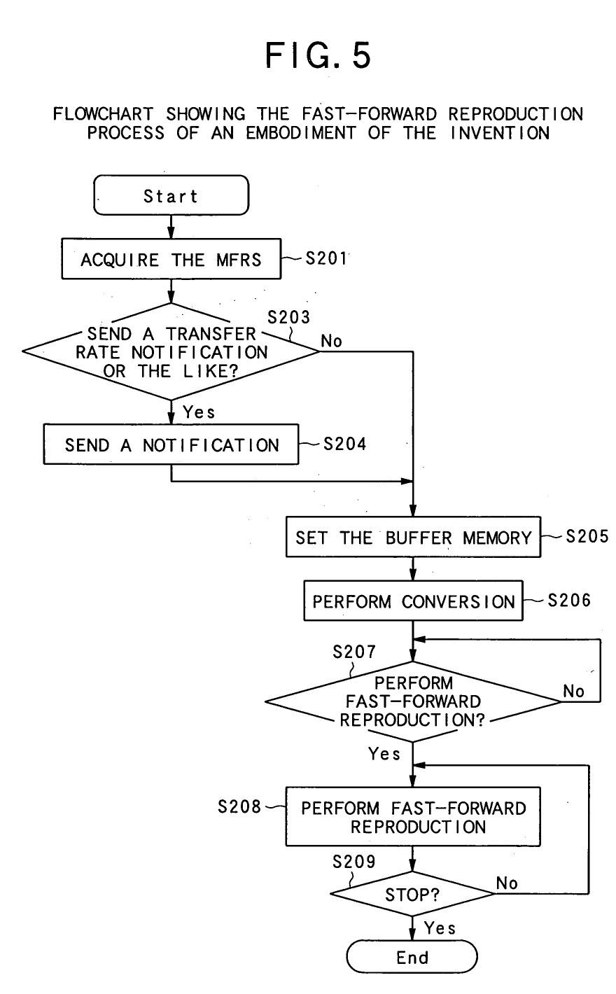

FIG. 2 and FIG. 3 are block diagrams showing the construction of the data-recording/reproduction apparatus, FIG. 4 is a flowchart showing the recording process by the data-recording/reproduction apparatus for recording digital data onto a hard disc HD, and FIG. 5 is a flowchart showing the fast-forward reproduction process of the reproduction processes by the data-recording/reproduction apparatus for reproducing digital data from a hard disc HD.

(A) Construction and Overall Operation

First, FIG. 2 will be used to explain the construction and overall operation of the data-recording/reproduction apparatus.

As shown in FIG. 2, the data-recording/reproduction apparatus S of this embodiment comprises: a digital-broadcast-sending/receiving unit 1 that connects to an antenna ANT; a recording unit 2 that functions as a recording device; a microcomputer unit 3 that functions as a maximum-data-amount-detection device that includes a memory 3A as a temporary memory device; a hard-disc unit 4 that includes a hard disc HD on which digital data is recorded according to the recording format shown in FIG. 1; a graphics unit 5; a video-decoding unit 6; a switch 7; a reproduction-control unit 8; and OSD (On Screen Display) unit 9; an HSI (High Speed Interface) unit 10; a portable remote-control unit 12; and a remote-control-receiving unit 11 that receives data sent by infrared rays or the like from the remote-control unit 12.

Also, as shown in FIG. 3, the reproduction-control unit 8 comprises: a reproduction unit 20; a conversion unit 21 that functions as a conversion device; and a switch 22.

Next, the overall operation will be explained.

First, the overall operation when using the data-recording/reproduction apparatus S to receive digital data in a digital broadcast that is broadcast by a broadcast signal, and to record that digital data onto a hard disc HD will be explained.

When recording digital data, the switch 7 is switched to the side of the recording unit 2.

At this time, the antenna ANT receives a broadcast signal and generates a receive signal Srr that corresponds to the received broadcast signal and outputs it to the digital-broadcast-receiving unit 1.

Next, under the control of the microcomputer unit 3 according to received control data Scn, the digital-broadcast-receiving unit 1 selects digital data from the received digital data that corresponds to a desired channel, and outputs it to one of the input terminals of the switch 7 and to the recording unit 2 as digital data Srn. At the same time, the digital-broadcast-receiving unit 1 detects the PID of the packets of the digital data in the selected channel, and outputs the contents to the microcomputer unit 3 as control data Scn.

Next, the recording unit 2 extracts the digital data to be recorded on the pre-selected hard disc HD from the digital data Srn, and then outputs that digital data continuously to the hard-disc unit 4, which includes the hard disc HD, as recording data Sr according to a recording rate that allows recording onto the hard disc HD. Also, in the recording process of this embodiment, which will be described later, the recording unit 2, detects the time position and the amount of data in the packet of the I picture indicated by the microcomputer unit 3, for all of the image data contained in the packet having the PID and output as control data Ssr from the microcomputer unit 3, and stores them temporarily as well as outputs them to the microcomputer unit 3.

After this, the hard-disc unit 4, under control from the microcomputer unit 3 according to received control data Ssh, records the recording data Sr, including control data such as the necessary digital data and maximum-size data MFRS, onto the built-in hard disc HD according to the recording format shown in FIG. 1.

On the other hand, when recording digital data, the video-decoding unit 6, to which recording data Srn is input as switching data Ssw by way of the switch 7, demodulates the digital data contained in the recording data Srn, and outputs it to the graphics unit 5 as demodulated data Sdc.

Also, the graphics unit 5 processes the image data contained in the demodulated data Sdc so it can be displayed, and outputs it to an external display (not shown in the figure) as display data Sv, which is an analog signal, and displays an image corresponding to the image data.

At the same time as the image processing by the video-decoding unit 6 and graphics unit 5 described above, the audio data contained in the recording data Srn is demodulated by an audio-decoding unit (not shown in the figure) and it is output by an external speaker (not shown in the figure).

Moreover, sub-images such as sub-titles or display source that correspond to the images contained in the demodulated data Sdc are generated separately by the OSD unit 9 under control from the microcomputer unit 3 according to a received control signal Sco, and output to the graphics unit 5 as OSD data Sosd.

The graphics unit 5 overlays the sub-image data contained in the OSD data Sosd as necessary over the demodulated data Sdc, and by combining these, generates the image data contained in the display data Sv.

From the series of recording operations described above, it is possible to record the image data contained in the received digital data onto to the hard disc HD while at the same time check the contents of that recorded image data on an external display (not shown in the figure).

Also, the microcomputer unit 3, by way of the remote-control-receiving unit 11, receives infrared light IR that is irradiated from the remote-control unit 12 that corresponds to operations performed using the remote-control unit 12 for controlling the executed recording process, and based on the operation data Sop output from the remote-control-receiving unit 11, generates control data Scn, Ssr and Ssf and outputs each to the corresponding unit, as well as performs overall control of the recording process. When doing this, the data required for overall control is stored temporarily in the memory 3A, and after that read and supplied to the necessary process.

When executing the recording process described above, the reproduction-control unit 8 and HSI unit 10 do not function.

Next, the operation when reproducing the digital data recorded on the hard disc HD by the recording process described above will be explained.

First, the normal reproduction process according to the original reproduction speed of the digital data will be explained.

In this normal reproduction process, the switch 7 is switched to the side of the reproduction-control unit 8, and the switch 22 inside the reproduction-control unit 8 is switched to the side of the reproduction unit 20.

Also, when a operation to indicate the start of the normal reproduction process is executed using the remote-control unit 12, the remote-control-receiving unit 11 receives the infrared ray irradiated from the remote-control unit 12 that corresponds to the start operation, and then based on the operation data Sop that is output from that remote-control-receiving unit 11, the microcomputer 3 generates control data Ssh for detecting digital data that was specified by the start operation from the hard disc HD, and sends it to the hard-disc unit 4.

After that, the hard-disc unit 4 detects the digital data specified by that control data Ssh from the hard disc HD and outputs it to the reproduction unit 20 of the reproduction-control unit 8 as detected data Sp.

Also, the reproduction unit 20 performs a preset reproduction process on the digital data contained in the detected data Sp and generates reproduction-processing data Spp, then sends it to switch 7 by way of switch 22 as reproduction data Spd.

This reproduction data Spd is input to the video-decoding unit 6 via the switch 7 as switch data Ssw, and the video-decoding unit 6 demodulates the digital data contained in the reproduction data and outputs it to the graphics unit 5 as demodulated data Sdc.

Also, as in the recording process described above, the graphics unit 5 processes the image data contained in the demodulated data Sdc so that it can be displayed, and outputs it to an external display (not shown in the figure) as display data Sv, and displays the image corresponding to the image data.

At the same time as the processing of the image by the video-decoding unit 6 and the graphics unit 5, the audio data contained in the reproduction data Spd is demodulated by the audio-decoding unit (not shown in the figure), and then output from an external speaker (not shown in the figure).

Moreover, sub-images such as sub-titles or the display source corresponding to the image contained in the demodulated data Sdc are generated by the OSD unit 9 under the control of the microcomputer unit 3 according to a received control signal Sco, and output to the graphics unit 5 as OSD data Sosd.

Also, the graphics unit 5 overlays the sub-image data contained in the OSD data Sosd onto the demodulated data Sdc to combine the images as necessary to generate the image data contained in the display data Sv.

On the other hand, in the case of digitally outputting the reproduction data Spd to an external digital television apparatus (not shown in the figure) for example, the reproduction data Spd is output to the HSI unit 10.

The HSI unit 10 digitally performs an interface process on the reproduction data Spd under the control of the microcomputer unit 3 according to received control data Scc, and outputs it to an external digital television apparatus or the like as digital output data Sdp. Both the image data and audio data are contained in the output data Sdp as digital data.

Next, the fast-forward reproduction process for fast-forward reproduction of the digital data recorded on the hard disc HD will be explained.

In the fast-forward reproduction process, the switch 7 is switch to the side of the reproduction-control unit 8, and the switch 22 inside the reproduction-control unit 8 is switched to the side of the conversion unit 21.

Also, when an operation is executed using the remote-control unit 12 to start the fast-forward reproduction process, the remote-control-receiving unit 11 receives infrared rays IR that are irradiated from the remote-control unit 12 corresponding to the start operation, and based on operation data Sop output from the remote-control-receiving unit 11, the microcomputer unit 3 generates control data Ssh for detecting the digital data from the hard disc HD for the fast-forward reproduction process specified by the start operation and outputs it to the hard-disc unit 4.

After that, the hard-disc unit 4 detects the digital data from the hard disc HD that was specified by the control data Ssh, and outputs it to the reproduction unit 20 of the reproduction-control unit 8 as detection data Sp. At the same as this, the hard-disc unit 4 detects data, as will be explained later, that is necessary for fast-forward reproduction such as the maximum-size data MFRS, and outputs it to the microcomputer unit 3 as control data Ssh.

Also, the reproduction unit 20 performs a preset reproduction process on the digital data contained in the detection data Sp and generates reproduction-processing data Sch for the fast-forward reproduction process, and temporarily stores it in an unrecorded area in the memory 3A of the microcomputer unit 3 that is used as a buffer space. At this time, the processing conditions necessary for the fast-forward reproduction processing, such as the storage capacity of the unrecorded area (buffer space) in the memory 3A needed for the temporary recording process, are saved by the microcomputer unit 3 according to data such as the maximum-size data MFRS that has already been output to the microcomputer unit 3 as will be explained later.

Next, the microcomputer unit 3 reads the temporarily stored reproduction-processing data Sch at the necessary timing, and outputs it to the conversion unit 21. Then, based on the reproduction-processing data Sch, the conversion unit 21 extracts only the I pictures from the image data in the original reproduction-processing data Sch and generates new digital fast-forward data Scv for the fast-forward-reproduction process, then outputs it to the switch 7 as reproduction data Spd by way of switch 22.

The reproduction data Spd is input by way of switch 7 to the video-decoding unit 6 as switch data Ssw, and the video-decoding unit 6 demodulates the digital data for fast-forward reproduction that is contained in the reproduction data Spd and outputs it to the graphics unit 5 as demodulated data Sdc.

As in the case of normal reproduction processing, the graphics unit 5 processes the image data for fast-forward reproduction that is contained in the demodulated data Sdc so that it can be displayed, and outputs it to an external display (not shown in the figure) as display data Sv, and performs fast-forward reproduction of the images corresponding to the image data.

On the other hand, in the case of digitally outputting the fast-forward reproduction data Spd to an external digital television apparatus (not shown in the figure) for example, the reproduction data Spd is output to the HSI unit 10.

The HSI unit 10 digitally performs an interface process on the reproduction data Spd under the control of the microcomputer unit 3 according to received control data Scc, and outputs it to an external digital television apparatus or the like as digital output data Sdp.

(B) Detailed Operation of the Recording Process

Next, the recording process of received digital data of this embodiment will be explained in detail using FIG. 2, FIG. 3 and FIG. 4.

In the recording process shown in FIG. 4, recording of the directory DIR contained at the beginning of unit Y (see FIG. 1) in the digital data starts when recording of that unit Y starts and ends when recording of that directory DIR ends, and it is presumed that both the fast-forward reproduction process and normal reproduction process are executed using that recorded digital data.

When recording received digital data onto the hard disc HD according to the recording format explained using FIG. 1 according to the start operation from the remote-control unit 12 (including the operation of selecting the channel of the digital data to be recorded on the hard disc HD), first, as initial settings: parameter PT, which is the parameter indicating the type of picture to be recorded is set to ‘I’ (I picture) for fast-forward reproduction; the value for parameter SPN, which is a parameter indicating the number of packets that have been recorded on the hard disc HD at the timing of the recording process to be described later, is set to ‘0’; the value of the index i for distinguishing the value of the parameter PPi for each picture, which is the number of the packet that corresponds to the starting position on the hard disc HD for recording the pictures (I pictures or other types of pictures) to be recorded at the present timing, and for distinguishing the value of the parameter PSi for each picture, which indicates the amount of data (size) of a picture recorded at the present timing, is set to ‘0’; and the value of the parameter PF, which is set to ‘1’ when the existence of a picture in the digital data received at the current timing is recognized, but the ending position of that picture on the hard disc is unknown, and is set to ‘0’ in all other cases, is set to ‘0’ (step S100).

Next, the PID, which indicates the packets contained in the digital data corresponding to the selected channel at that time and which contains the images, is acquired as control data Scn from the digital-broadcast-receiving unit 1 that receives the broadcast signal (hereafter, the PID that indicates the packets containing images will be called the video PID) (step S101).

After that, the microcomputer unit 3 sends the acquired video PID and a notification that the pictures to be recorded are I pictures to the recording unit 2 as control data Ssr, and also initializes the value of the maximum-size data MFRS, which is the maximum value for the amount of data in each I picture that is to be recorded (to be detected as being for fast-forward reproduction), to ‘0’, and furthermore, from the digital data Srn, the recording unit 2 starts detecting packets having the same PID as the video PID output from the microcomputer unit 3, and starts detecting and recording the necessary I pictures (step S102).

At the same time, recording of digital data onto the hard disc HD starts based on the control data Ssr and Ssh from the microcomputer unit 3 (step S103).

When recording digital data, the remote-control unit 12 is constantly monitored for an operation that ends recording (step S104), and when there is an operation that ends recording (step S104; YES), the maximum-size data MFRS at that time is recorded on the hard disc HD according to the recording format shown in FIG. 1 (step S115) and the recording process ends.

On the other hand, in the judgment of step S104, when there has been no operation to stop recording (step S104; NO), packets of digital data continue to be input and the recording process continues (step S105), and it is determined whether or not a packet containing image data has been input (step S106).

When a packet containing image data is not input (step S106; NO), the parameter SPN for repeating the same process for the next packet is increased by an increment of ‘1’ (step S110) and the process returns to step S104.

On the other hand, in the judgment of step S106, when a packet containing image data has been input (step S106; YES), next, the value of the parameter PF is checked at the current timing whether or not it is ‘0’ (step S107). When the value of the parameter PF is ‘0’, (step S107; YES), it means that the recording end position of the type of picture at the current timing is recognized, so next, it is determined whether or not that picture is the same as the image specified by the parameter PT in step S100, that is, the picture is checked whether it is an I picture (step S108).

Moreover, when the picture recognized at that recording end position is an I picture (step S108; YES), the recording start position of the I picture, which is used for fast-forward reproduction processing, on the hard disc HD is recognized at this instant, so next, the value of the parameter SPN that corresponds to that recording start position is set as the value of the parameter PPi, and furthermore, the value of the parameter PF that executes the aforementioned process for the next picture is set to ‘1’ (step S109) and the process goes to step S110.

On the other hand, in the judgment of step S108, when the picture recognized at the recording end position is not an I picture (step S108; NO), the process advances to step S110 to record the most recent I picture.

However, in the judgment of step S107 when the value of the parameter PG is not ‘0’, or in other words, when it is ‘1’ (step S107; NO), the recording end position for the type of picture is not recognized at the current timing, and at that current timing the search for image data in picture is in progress, so searching for the recording end position continues and the difference between the parameter PPi and the current parameter SPN is set as the new parameter PS1 (step S111).

Next, the value of the parameter PSi at the timing right after the processing of step S111 and the value recorded as the maximum-size data MFRS at that timing are compared (step S112), and when the value of the parameter PSi is less than the value of the maximum-size data MFRS (step S112; NO), it means that of the pictures detected up to that point, no picture was recorded that has an amount of data greater than the I picture having the maximum amount of data, so the current recording of pictures continues and the process advances to step S108 to determine the type of picture and the process described above is repeated.

On the other hand, in the judgment of step S112, when the value of the parameter PSi at the current timing is greater than the value of the maximum-size data MFRS (step S112; YES), it means that a picture is currently being recorded that has an amount of data that is greater than the I picture having the maximum amount of data detected up to that point, so the picture that is currently being recorded becomes the new I picture having the maximum amount of data of the pictures recorded up to that point, and the current value of the parameter PSi is set and recorded as the new maximum-size data MFRS (step S113), the index i for the parameter PPi and PSi is increased by an increment of ‘1’ (step S114), and the type of that picture (normally an I picture) whose data amount is recorded as the maximum-size data MFRS is determined (step S108), and the process described above is repeated.

By continuing the recording process described above and recording digital data Srn, the data amount of the I picture having the maximum amount of data of the I pictures used for fast-forward reproduction is recorded as the maximum-size data MFRS.

(C) Detailed Operation of the Fast-Forward Reproduction Process

Next, the fast-forward reproduction process of reproducing digital data from the hard disc HD of this embodiment will be explained in detail using FIG. 2, FIG. 3 and FIG. 5.

The fast-forward reproduction process explained below is a fast-forward reproduction process that is executed by using the maximum-size data MFRS recorded by the recording process described above while performing the necessary settings.

When a start operation using the remote-control unit 12 is performed to execute fast-forward reproduction of the digital data received according to the recording format explained using FIG. 1, and as shown in FIG. 5, first, the maximum-size data MFRS that is already recorded is detected (step S201), then, it is determined whether or not it is necessary to send a notification to the outside of the transfer rate and bandwidth (hereafter, simply called the transfer rate) in the case of transferring the digital data for fast-forward reproduction from the HSI unit 10 (this notification could be sent the to an external digital television apparatus or the like to which the digital data is to be transferred) (step S203), and when it is necessary, that transfer rate is calculated using the maximum-size data MFRS that is currently detected (step S204) and then the process advances to step S205.

On the other hand, in the judgment of step S203, when it is not necessary to send a notification (step S203; NO), then a buffer space for generating new data Scv for fast-forward reproduction is set aside in the unrecorded area in the memory 3A of the microcomputer unit 3 (step S205). At this time, the memory capacity of the buffer space is set using the detected maximum-size data MFRS as a reference so that the memory capacity is as small as possible without problems such as overflow occurring.

Moreover, when the buffer space is set, that buffer space is used to temporarily store the reproduction-processing data Sch so that the conversion unit 21 can generate data Scv for fast-forward processing (step S206).

After that, it is determined whether or not there was an operation from the remote-control unit 12 giving an instruction to start the fast-forward reproduction process using the fast-forward data Scv that was generated (step S207), and when there is no start instruction to start fast-forward reproduction (step S207; NO), the process pauses until there is a start instruction, however when there is a start instruction (step S207; YES), the actual fast-forward reproduction process is performed using the fast-forward data Scv that was generated (step S208).

Moreover, the remote-control unit 12 is monitored as to whether or not it was used to send an end instruction during fast-forward reproduction (step S209), and when there is no end instruction (step S209; NO), the fast-forward reproduction process continues as is, however, when there is an end instruction (step S209; YES), fast-forward reproduction ends.

In the case of executing the normal speed reproduction process by the data-recording/reproduction apparatus S of this embodiment, the reproduction process is executed according to the overall operation described above.

As explained above, with the operation of the data-recording/reproduction apparatus S of this embodiment, when recording digital data, the amount of data in the I picture containing the maximum amount of data of any of the I pictures used for the fast-forward reproduction process is recorded on the hard disc HD, so in the fast-forward reproduction process of the recorded digital data, it is possible to use the I picture to properly and efficiently set the conversion specification, such as the memory capacity of a buffer space used when converting digital data to fast-forward data Scv.

Therefore, when performing the fast-forward process, it is not necessary to detect the amount of data for all of the I pictures, so it is possible to simplify the construction of the data-reproduction that performs the fast-forward reproduction process, and it is possible to reduce the processing burden when performing fast-forward reproduction.

Also, the conversion element is set based on the amount of data of the I picture recorded on the hard disc HD that contains the maximum amount of data of any of the I pictures, and fast-forward data Scv is generated based on that set conversion specification, so it is possible to generate the fast-forward data Scv efficiently without affecting any other processes.

Moreover, the conversion element is the memory capacity of the memory area in the memory 3A secured as a buffer area, so it is possible to maintain a buffer space having a minimum necessary memory capacity such that the memory 3A is not unnecessarily used.

Furthermore, the bandwidth for transferring fast-forward data Scv using the HSI unit 10 is included in the conversion specification, so it is possible to optimize the required amount of bandwidth when outputting the fast-forward data Scv after conversion to the outside.

In the embodiment described above, the case of securing a buffer space having the necessary amount of memory capacity for generating fast-forward data Scv, and the case of using maximum-size data MFRS when setting the bandwidth for external transfer were explained, however, in addition to these, it is possible to use the maximum-size data MFRS in the required source settings for executing other special reproduction processes such as fast-reverse reproduction.

Also, by recording programs corresponding to the flowcharts shown in FIG. 5 and FIG. 6 and described above on a data-recording medium such as a flexible disc or hard disc, or by acquiring the programs via a network such as the Internet and recording them, and executing them on a general-purposes personal computer it is possible to have a personal computer function as the microcomputer unit 3 of this embodiment.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2002-304732 filed on Oct. 18, 2002 including the specification, claims, drawings and summary is incorporated herein by reference in its entirety.

What is claimed is:

1. A data-recording apparatus that records video images comprising a plurality of still images, onto a recording medium and comprising:
a maximum-data-amount-detection device for detecting the maximum amount of data of a still image for special reproduction among a plurality of still images; and
a recording device for recording said detected maximum amount of data onto said recording medium on which said video images are recorded.

2. The data-recording apparatus according to claim 1, wherein
said video images are video images that have been compressed according to the MPEG2 (Motion Picture Experts Group 2) method; and wherein
said still images for special reproduction are the I (Intra-coded) pictures in said MPEG2 method.

3. A data-reproduction apparatus that reproduces said video images that are recorded on said recording medium by the data-recording apparatus according to claim 1, and converts them into special reproduction images for said special reproduction and comprising:
a reproduction device for reproducing said video images from said recording medium;
a detection device for detecting said recorded maximum data amount from said recording medium;
a setting device for setting conversion specification based on said detected maximum data amount when converting said video images to said special-reproduction images; and
a conversion device for converting said reproduced video images to said special-reproduction images based on said set conversion specification.

4. The data-reproduction apparatus according to claim 3, wherein
said conversion specification is memory capacity of a temporary memory device for temporarily storing video images when converting said video images to said special-reproduction images, and the temporary memory device is secured inside a memory device of said data-reproduction apparatus.

5. The data-reproduction apparatus of claim 3, wherein
said conversion specification is the bandwidth used when outputting said special-reproduction images to the outside after conversion.

6. A data-recording method for recording video images comprising a plurality of still images, onto a recording medium and comprising:
a maximum-data-amount-detection process for detecting the maximum amount of data of a still image for special reproduction among a plurality of still images; and
a recording process for recording said detected maximum amount of data onto said recording medium on which said video images are recorded.

7. A data-reproduction method for reproducing said video images that are recorded on said recording medium by the data-recording method according to claim 6, and converts them into special-reproduction images for said special reproduction and comprising:
a reproduction process for reproducing said video images from said recording medium;
a detection process for detecting said recorded maximum data amount from said recording medium;
a setting process for setting conversion specification based on said detected maximum data amount when converting said video images to said special-reproduction images; and
a conversion process for converting said reproduced video images to said special-reproduction images based on said set conversion specification.

8. A computer data signal embodied in a carrier wave and representing a sequence of instructions, which executed by a recording computer included in a data-recording apparatus, which records video images comprising a plurality of still images onto a recording medium, the instructions cause the recording computer to function as:
a maximum-data-amount-detection device for detecting the maximum amount of data of a still image for special reproduction among a plurality of still images; and
a recording device for recording said detected maximum amount of data onto said recording medium on which said video images are recorded.

9. A computer data signal embodied in a carrier wave and representing a sequence of instructions, which executed by a reproduction computer included in a data-reproduction apparatus, which reproduces said video images that are recorded on said recording medium by a data-recording apparatus according to claim 1 and converts them into special reproduction images for said special reproduction, the instructions cause the computer to function as:
a reproduction device for reproducing said video images from said recording medium;
a detection device for detecting said recorded maximum data amount from said recording medium;
a setting device for setting conversion specification based on said detected maximum data amount when converting said video images to said special-reproduction images; and
a conversion device for converting said reproduced video images to said special-reproduction images based on said set conversion specification.

10. A data-recording medium in which a program for recording data is recorded so as to be readable by a recording computer included in a data-recording apparatus according to claim 1, wherein said program allows said recording computer to function as:
a maximum-data-amount-detection device for detecting the maximum amount of data of a still image for special reproduction among a plurality of still images; and
a recording device for recording said detected maximum amount of data onto said recording medium on which said video images are recorded.

11. A data-recording medium in which a program for reproducing data is recorded so as to be readable by a reproduction computer included in said data-reproduction apparatus according to claim 3, wherein said program allows said reproduction computer to function as:
a reproduction device for reproducing said video images from said recording medium;
a detection device for detecting said recorded maximum data amount from said recording medium;
a setting device for setting conversion specification based on said detected maximum data amount when converting said video images to said special-reproduction images; and
a conversion device for converting said reproduced video images to said special-reproduction images based on said set conversion specification.

12. A recording medium comprising:
a video-image-recording area in which video images comprising a plurality of still images are recorded; and
a maximum-data-amount-recording area in which the maximum amount of data of a still image for special reproduction among a plurality of still images is recorded.

13. The recording medium according to claim 12, wherein
said video images are video images that have been compressed according to the MPEG2 method; and wherein
said still images for special reproduction are the I pictures in said MPEG2 method.
